(19) United States
(12) Patent Application Publication
(10) Pub. No.: US 2025/0230075 A1
(43) Pub. Date: Jul. 17, 2025

(54) ELECTROCHEMICAL ION EXTRACTION APPARATUS AND METHOD OF USE

(71) Applicant: UNIVERSITY OF SOUTH CAROLINA, COLUMBIA, SC (US)

(72) Inventors: ZHENMENG PENG, COLUMBIA, SC (US); RONGXUAN XIE, COLUMBIA, SC (US)

(21) Appl. No.: 19/022,351

(22) Filed: Jan. 15, 2025

Related U.S. Application Data
(60) Provisional application No. 63/621,168, filed on Jan. 16, 2024.

(51) Int. Cl. C02F 1/469; C02F 101/10; C02F 103/08

(52) U.S. Cl. CPC C02F 1/4695; C02F 2101/10; C02F 2103/08; C02F 2201/46115; C02F 2201/46165; C02F 2201/4618

(57) ABSTRACT

Disclosed are ion extraction electrochemical cells, systems incorporating the cells, and applications thereof, including but not limited to selective ion extraction from seawater/brine for mining operations, recycling operations, and isotope separations. Methods include extraction of metals or isotopes from an aqueous phase, e.g., mining of metals from saltwater or synthetic or natural brines. Systems and methods can be utilized in one embodiment for lithium mining.

### CROSS REFERENCE TO RELATED APPLICATION

This application claims filing benefit of U.S. Provisional Patent Application Ser. No. 63/621,168 having a filing date of Jan. 16, 2024, which is incorporated herein by reference for all purposes.

### BACKGROUND

Valuable metals are still obtained primarily from ores. Traditional mining of ores is time-and capital-costly and disastrous for the local environment. Considering the environmental costs and limitations of traditional ore mining, improvements to methods for metal extraction from ores as well as development of techniques for metal extraction from other sources is necessary.

Seawater and underground brines contain the world's largest amounts of various valuable metals in their ionic form. For instance, seawater contains an estimated 230 billion tons of lithium, dissolved mainly as lithium salts, as well as huge quantities of other valuable metals including uranium, silver, zinc, manganese, and copper, just to name a few. Unfortunately, the concentrations of such desirable materials are relatively low, and there exist interfering ions, such as magnesium, calcium, and sodium, which cause difficulty and cost-effectiveness issues for mineral mining from seawater and brine.

Traditional methods of metal mining from water sources include extraction, adsorption, salt-field enrichment precipitation, calcination infiltration, and sun pond method. Each process is limited by drawbacks such as long operation time, requirement of a large area, and byproduct issues. For instance, brine mining typically includes injecting water into salt deposits through deep boreholes. The water dissolves the salt deposits, creating a rich brine that is then pumped up to the surface. The brine is pumped into shallow ponds and is left in the sun to evaporate. When most of the water in a pond has evaporated, which can be up to two years later, the concentrated brine can be harvested.

Membrane-based extraction techniques have been developed in an attempt to improve water source mining methodologies. Nanofiltration processes are commonly used in membrane extraction techniques to pre-concentrate and extract metal ions from seawater/brine. Unfortunately, nanofiltration methods have low selectivity for monovalent ions, which restrains capability of such methods to extract valuable monovalent ions such as lithium. Electromigration employed with ion exchange membranes has been widely examined for use in seawater desalination via ion separation. Unfortunately, ion exchange membranes do not have sufficient ion selectivity to separate different types of ions.

What are needed in the art are apparatuses, systems, and methods for selective extraction of targeted ions from salt solutions such as seawater and natural or synthetic brines.

### SUMMARY

According to one embodiment, disclosed is an electrochemical cell for selective extraction of a targeted ion from a salt solution. An electrochemical cell can include a first electrode and second electrode configured for electrical communication with a power supply. A cell can also include an electrode electrolyte solution that includes a redox component. A flow path of the cell is configured to circulate the electrode electrolyte solution between first and second areas adjacent to the first and second electrodes, respectively. The electrochemical cell also includes a third area and a fourth area, e.g., liquid reservoirs or liquid flow paths. The third area is separated from the first area by a first ion exchange membrane, the fourth area is separated from the second area by a second ion exchange membrane, and the third and fourth areas are separated from one another by an ion-selective membrane.

Also disclosed are systems that incorporate an electrochemical cell. For instance, a system can include a power supply in electronic communication with the first and second electrodes of an electrochemical cell. A system can also include pumps, lines, etc. for moving a salt solution to and from a designated area of the cell. Pumps, lines, etc. can also be employed for providing a receiving solution to and from another designated area of the cell as well as for cycling an electrode electrolyte solution between the first and second electrodes. In some embodiments, the system can be designed to cycle the salt solution and/or the receiving solution through their respective areas. In various embodiments, the system can be designed for batch, semi-batch, or continuous operation.

Also disclosed are methods for extracting a targeted ion from a salt solution. A method can include providing a salt solution to an electrochemical cell and providing a receiving solution to the electrochemical cell, such that the two solutions are separated from one another by an ion-selective membrane. The salt solution can contain the targeted ion of interest, e.g., lithium. The method can also include establishing a voltage potential across first and second electrodes of the electrochemical cell and circulating an electrode electrolyte solution between the first and second electrodes. The electrode electrolyte solution can include a redox component that is oxidized at the first electrode and that is reduced at the second electrode. Due to the resulting change in charge of the electrode electrolyte solution at the first electrode, ions will migrate from the salt solution to the electrode electrolyte solution at the first electrode through a first ion exchange membrane. This migration leads to a change in charge of the salt solution, upon which targeted ions of the salt solution can preferentially migrate from the salt solution to the receiving solution through an ion-selective membrane that separates the two solutions. At the second electrode, the redox component can be reduced and due to the resulting change in charge of the electrode electrolyte solution at the second electrode, ions will migrate from the electrode electrolyte solution at the first electrode to the receiving solution through a second ion exchange membrane. Through this process, the receiving solution can become enriched in the targeted ion.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 schematically illustrates one embodiment of an electrochemical cell as described herein.

FIG. 2 schematically illustrates one embodiment of a system as described herein.

FIG. 3 schematically illustrates one embodiment of a multi-cell system as described herein.

FIG. 4 schematically illustrates the ionic flow and redox reactions of a lithium enrichment method and system as disclosed herein.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

The present disclosure relates generally to the field of selective ion extraction from an aqueous phase. More specifically, disclosed herein is an ion extraction electrochemical cell and system and applications thereof, including but not limited to selective ion extraction from seawater/brine for mining operations, recycling operations, and isotope separations. In one embodiment, the disclosure is directed to extraction of metals from an aqueous phase, e.g., mining of metals from saltwater or synthetic or natural brines. In one embodiment, the disclosure is directed to the extraction of an isotope from an aqueous phase, e.g., enrichment of an aqueous phase in a particular isotope.

Disclosed systems incorporate a flow electrode electrochemical cell that includes an ion-selective membrane that can effectively concentrate targeted ions during use. Disclosed systems can successfully overcome existing issues of saltwater extraction and can be applied for selectively extracting and concentrating ions of choice from a saltwater solution, e.g., seawater or brine. Employment of an ion-selective membrane in the electrochemical systems can significantly improve ion selectivity as compared to previously known ion exchange systems. Moreover, materials and components as may be utilized in disclosed systems can be low-cost and safe for use in environments of interest, which can provide further benefit to the art. By use of disclosed systems, low-cost, efficient, and simple operation can be employed in targeted ion extraction for production of a wide range of ions and isotopes.

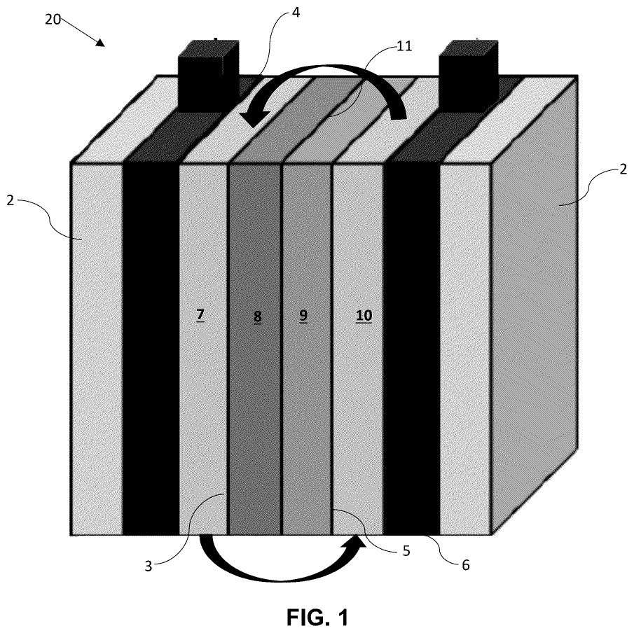

One embodiment of an electrochemical cell is illustrated in FIG. 1. As illustrated, an electrochemical cell 20 can include end plates 2. The cell 20 can also include a first electrode 4 and a second electrode 6 at either side of areas 7, 8, 9, and 10. Areas 7, 8, 9, and 10 can be reservoirs, flow fields, or any combination thereof that allows for liquid flow therethrough, optionally in conjunction with liquid retention therein. The areas 7, 8, 9, and 10 are separated from one another by a first ion exchange membrane 3 that separates area 7 and area 8, a second ion exchange membrane 5 that separates area 9 and area 10, and an ion selective membrane 11 that separates area 8 and area 9.

The end plates 2 and the electrodes 4 and 6 can include standard components and materials as are generally known in the art. By way of example, the end plates 2 can be the same or different from one another and can function as end plates of a single cell system and/or end plates of a stacked multi-cell system. The end plates 2 are generally designed to support the other components of the cell, prevent leakage, and minimize heat loss. In one embodiment the end plates 2 can be formed of a steel, e.g., stainless steel, or a suitable polymeric composite material.

The electrodes 4, 6 can be the same or different from one another and are generally formed of materials appropriate for the electrode electrolyte solution that will circulate through the cell 20. In one embodiment, each electrode 4, 6 can include one or more of, and without limitation to, zinc, iron, chromium, nickel, lead, titanium, copper, tin, silver, lead(IV) oxide, manganese(IV) oxide, sulfur, Prussian blue, Prussian blue derivatives, transition metal analogs of Prussian blue, carbon fiber, graphite, carbon felt, conductive carbon black, as well as other other conductive forms of carbon. By way of example an electrode 4, 6 can include one or more layers including, without limitation, a separator, e.g., a porous carbon paper, carbon cloth, carbon felt, or metal cloth (e.g., a porous film made of fiber-type metal or a metal film formed on the surface of a polymer fiber cloth), a conductive substrate appropriate for the electrode electrolyte solution of the cell (e.g., graphite), and a current collector (e.g., gold-plated copper). In some embodiments, the conductive substrate can also function as the current collector. Alternatively, a cell 20 can include a current collector as a separate component of the electrode in conjunction with a conductive substrate. The current collector can provide electrical communication between the cell 20 and an exterior power supply.

As indicated, the apparatus can be designed such that flow of an electrode electrolyte solution can be cycled between area 7 and area 10. The electrode electrolyte solution can be an aqueous solution that includes a redox component. The redox component can be oxidized at the first electrode 4 and reduced at the second electrode 6 as the solution is cycled through the cell 20 under a voltage potential established between the first and second electrodes 4, 6.

The electrode electrolyte solution can include at least one redox component that is capable of a reversible redox reaction under the voltage potential of the cell, providing a reversible redox pair. By way of example, and without limitation, the redox component can include one or more of, and without limitation to, an ion of titanium (titanium(III), titanium(IV)), vanadium (vanadium(II), vanadium(III), vanadium(IV), vanadium(V)), chromium (chromium(II), chromium(III), chromium(VI)), manganese (manganese(II), manganese(III), manganese(VI), manganese(VII), iron (iron(II), iron(III), iron(VI)), cobalt (cobalt(II), cobalt(III)), nickel (nickel(II)), copper (copper(I), copper(II)), zinc (zinc(II)), ruthenium (ruthenium(II), ruthenium(III)), tin (tin(II), tin(IV)), cerium (cerium(III), cerium(IV)), tungsten (tungsten(IV), tungsten(V)), osmium (osmium(II), osmium(III)), lead (lead II), zincate, aluminate, chlorine, chloride, bromine, bromide, tribromide, iodine, iodide, triiodide, polyhalide, halide oxyanion, sulfide, polysulfide, sulfur oxyanion, ferrocyanide, ferricyanide, a quinone derivative, an alloxazine derivative, a flavin derivative, a viologen derivative, a metallocene derivative (e.g., a ferrocene derivative), a nitroxide radical derivative, a N,N-dialkyl-N-oxoammonium derivative, a nitronyl nitroxide radical derivative, and/or polymers incorporating complexed or covalently bound components of any of the aforementioned materials.

By way of example, a redox component can be present in the electrode electrolyte solution as a salt such as, and without limitation to cerium chloride, germanium chloride, vanadium chloride, europium chloride, and ferrous chloride.

A redox pair of the electrode electrolyte solution can be an anion-based pair or a cation-based pair. For instance, a solution can include an anion-based redox component such as an aluminum-based Al(OH)₄⁻/Al redox pair, a zinc-based Zn(OH)₄²⁻/Zn redox pair, a sulfur-based S₄²⁻/S₂²⁻ redox pair, a cobalt-based Co(CN)₆³⁻/Co(CN)₆⁴⁻, or a bromine Br₃⁻/Br⁻ redox pair. Examples of cation-based redox components can include, without limitation, vanadium based redox pairs such as vanadium-based VO⁺/VO²⁺ or V³⁺/V²⁺ redox pairs, a zinc-based Zn²⁺/Zn redox pair, a cerium-based Ce⁴⁺/Ce³⁺ redox pair, a chromium-based Cr³⁺/Cr²⁺ redox pair, an iron-based Fe³⁺/Fe²⁺ redox pair, a cobalt-based Co³⁺/Co²⁺ redox pair, etc.

In addition to one or more compounds capable of providing the desired redox pair, the electrode electrolyte solution can include one or more solutes and solvents, pH buffers, etc. as are generally known in the art. For instance, a solution can include a pH buffer that may or may not be redox-active under typical operating conditions. In one embodiment, the pH of the electrode electrolyte solution can be matched to the pH of the salt solution that includes the targeted ion. As such, the electrode electrolyte solution can be approximately neutral (e.g., pH from about 5 to about 9), acidic (e.g., pH less than about 5), or alkaline (e.g., pH greater than about 9), depending upon the characteristics of the system and the particular method.

In general, a higher concentration of the redox component can result in higher frequency of redox chemicals to react on the electrode surface that promotes the cell current and thus higher ion extraction rate. In practice, the concentration for the redox component for use can vary with specific redox chemicals and can generally depend upon their saturation solubility. For example, disodium ferrocene-1,1′-bis(sulfonate) (1-1′ FcDs) based redox couple, limited by its solubility, can reach a concentration of about 0.3M. Diethylenetriamine pentaacetic acid, iron(III) salt (Fe-DTPA) based redox couple can reach a higher concentration of about 1 M. Fe²⁺/Fe³⁺ based redox couple can reach as high as about 5 M. In some embodiments, the redox component can be present in a solution in a concentration of from about 0.1 M to about 5 M, for instance from about 0.1 M to about 0.5 M, from about 0.1 M to about 1 M, from about 0.5 M to about 5 M, or from about 1 M to about 5 M, such as from about 2 M to about 4 M in some embodiments.

The form, size, and geometry of the areas 7, 10 through which the electrode electrolyte solution can be cycled for interaction with the respective electrode 4, 6, and ion exchange membrane 3, 5 is not particularly critical. For example, in some embodiments, the areas 7, 10, can be relatively large reservoirs, such as in those embodiments in which the electrode electrolyte solution is pumped into the respective areas 7, 10, and retained therein for a period such as in a batch-type operation. In other embodiments, the areas 7, 10 can be designed such that the electrode electrolyte solution is continually pumped or otherwise cycled through the areas 7, 10. In such an embodiment, the areas 7, 10 can define relatively large, open volumes or can define a plurality of flow channels or the like to encourage contact between the electrode electrolyte solution and the electrode 4, 6, in conjunction with providing for contact between the electrode electrolyte solution and an ion exchange membrane 3, 5.

The ion exchange membranes 3, 5, can be anion exchange membranes or cation exchange membranes, depending on the nature of the ion targeted for separation by the system and the redox component of the electrode electrolyte solution. While both ion exchange membranes 3, 5 will be either anion exchange membranes or cation exchange membranes, they can be of the same composition or different, as desired.

The ion exchange membranes 3, 5 may be water permeable. The ion exchange membranes 3, 5 may include, but are not limited to, commercially available membranes and membranes with chemical modifications. Non-limiting examples of such modifications are: (i) perfluorinated films with fixed pyridine or sulfonic groups; (ii) polyetherketones; (iii) polysulfonones; (iv) polyphenylene oxides; (v) polystyrene; (vi) styrene-divinyl benzene; (vii) polystyrene/acrylic based fabrics with sulfonate and quaternary ammonium cations; (viii) polyfluorinated sulfuric acid polymers; or (ix) resin-polyvinylidenedifluoride fabrics.

An anion exchange membrane as may be incorporated in an electrochemical call can include a membrane that allows passage of anions and does not allow passage of cations. In one embodiment, an anion exchange membrane can be a negative-valence selective membrane that allows passage of anions having a negative charge greater than a cut-off value while not allowing passage of anions having a negative charge less than the cut-off value.

Examples of anion exchange membranes as may be incorporated in an electrochemical cell can include, without limitation, those marketed under the tradename NEOSEPTA® and being of the grade AM-1, AMX, ACS and ACS-3, available from Tokuyama Corp., Tokyo, Japan; those marketed under the tradename FUMASEP® FAB, available from FuMA-Tech GmbH, Germany; and those marketed under the tradename ZIRFON®, available from Agfa Corp.

A cation exchange membrane as may be incorporated in an electrochemical call can include a membrane that allows passage of cations and does not allow passage of anions. In one embodiment, a cation exchange membrane can be a positive-valence selective membrane that allows passage of cations having a positive charge greater than a cut-off value while not allowing passage of cations having a positive charge less than the cut-off value.

Examples of cation exchange membranes as may be incorporated in an electrochemical cell can include, without limitation, those marketed under the tradename NEOSEPTA® and being of grade CM-1, CMX, CMS and CIMS, available from Tokuyama Corp., Tokyo, Japan; a sulfonated-tetrafluoroethylene-based fluoropolymer-copolymer commercially available under the tradename NAFION®, available from E. I. du Pont de Nemours and Company;

Referring again to FIG. 1, the ion exchange membranes 3, 5 can be adjacent the areas 7, 10 on a first side of each membrane, so as to contact the electrode electrolyte solution at each electrode 4, 6, respectively. On the second, opposite side of the ion exchange membrane 3, the membrane 3 can contact a salt solution that can be retained in and/or passed through area 8. On the second, opposite side of the ion exchange membrane 5, the membrane 5 can contact a receiving solution that can be retained in and/or passed through area 9.

As with the areas 7, 10, designed for the electrode electrolyte solution, the form, size, and geometry of the areas 8, 9, designed for the salt solution and the receiving solution, respectively, is not particularly critical. For example, in some embodiments, the areas 8, 9, can be relatively large reservoirs, such as in those embodiments in which the salt solution and the receiving solution is pumped into the respective areas 8, 9, and retained therein for a period such as in a batch-type operation. In other embodiments, the areas 8, 9 can be designed such that the salt solution and/or the receiving solution is continually pumped or otherwise cycled through their respective area 8, 9. In such an embodiment, the areas 8, 9 can define relatively large, open volumes or can define a plurality of flow channels or the like to encourage contact between the solution and the membranes on either side of the solution.

Separating the areas 8, 9 is an ion-selective membrane 11 that is selective for the targeted ion. The ion-selective membrane can include any of a variety of ceramic materials, including but not limited to oxides, sulfides, selenides, phosphates, silicates, perovskites, zeolites, layered hydroxides, as well as their composites with polymers. The preferred ion-selective membrane can depend upon the targeted ion of a process as it is conductive for the targeted ion and provides for ion-selective extraction from the salt solution to the receiving solution on the opposite side of the membrane 11.

By way of example and without limitation, in an embodiment directed to lithium mining, a lithium selective ceramic membrane can be utilized, examples of which include LiFePO₄ and perovskite-type materials such as lithium lanthanum titanate (LLTO). The ion selective membrane of choice can have a unique crystal structure that forms “tunnels” allowing the targeted ion to move from one site to another across the membrane, with the charge gradient between the salt solution and the electrode electrolyte solution across the ion exchange membrane 3 and the concentration gradient between the salt solution and the receiving solution across the ion-selective membrane 11 providing drive for the targeted ion movement from the salt solution in area 8 to the receiving solution in area 9.

Moreover, through utilization of the difference in migration coefficients between elemental isotopes, such as ⁶Li⁺ versus ⁷Li⁺, disclosed systems can also be utilized for isotope separation of targeted ions from a salt solution. By way of example, in one embodiment, the targeted ion can be a proton or an isotope thereof. In such an embodiment, the ion selective membrane 11 can include a proton exchange membrane that selectively passes protons across the membrane. As with other materials, through utilization of the difference in migration coefficients between the hydrogen isotopes the systems and methods can be utilized in separation of hydrogen isotopes, primarily protium, deuterium, and tritium,

Of course, disclosed electrochemical cells can be utilized to target many other ions from a salt solution, including, without limitation, zinc (Zn²⁺), uranium (U⁴⁺), manganese (Mn²⁺), magnesium (Mg²⁺), copper (Cu²⁺), silver (Ag⁺), etc. Any ion selective membrane as is known in the art that is selective for the ion of choice can be utilized in an electrochemical cell. Ion selective ceramic membranes as are available can be matched with the targeted ion of choice and utilized in an electrochemical cell as disclosed herein. For example, Li_{6/16}Sr_{7/16} Ta_{3/4}Hf_{1/4}O₃ perovskite membrane can be utilized in one embodiment for Li ion extraction, which can show outstanding selectivity and stability. Other membranes based on other types of Li-containing compounds can alternatively be utilized, such as, and without limitation to, LiₓFePO4 and LiₓMnO₂. Ionophore-incorporated membranes can be utilized used for selective permeation of other types of metal ions. A few non-limiting examples of ionophores for different metal ions can include, without limitation, for Zn²⁺: dibenzo-24-crown-8, tetrabutylthiuram disulphide, hemotophorphyrin IX; for U⁴⁺: uranyl-TETA complex, benzo-15-crown-5; for Mn²⁺: N-(2-picolinamido ethyl)-picolinamide, pentaazamacrocyclic manganese complex; for Mg²⁺: magnesium ionophore I (N,N′-Diheptyl-N,N′-dimethyl-1,4-butanediamide); for Cu²⁺: o-Xylylenebis(N,N-diisobutyldithiocarbamate); For Ag⁺: 2-(Octadecyloxymethyl)pyridine.

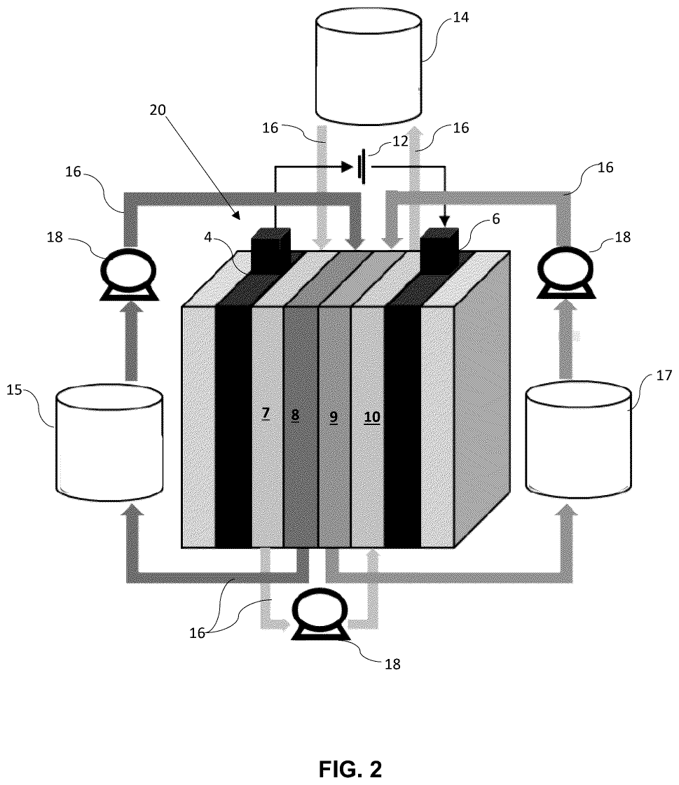

FIG. 2 illustrates one embodiment of a system that can incorporate one or more electrochemical cells 20 in separation of a targeted ion of choice. As illustrated, a system can include an electrochemical cell 20 in conjunction with a power supply 12, pumps 18, flow lines 16, and storage tanks 14, 15, 17, as well as other known system components, the use of which would be well known to those of the art and as such are not described in detail herein.

The electrochemical cell 20 can be driven by standard electrical power as well as other energy sources such as green energy solar panels and wind-driven generators. As used herein, a power supply or power supply unit can be any system or mechanism for supplying power. It should be noted that both AC and DC power supply units are contemplated in any embodiment herein where a power supply is exemplified, regardless of whether so stated and notwithstanding specific reference to an AC or DC power supply. In general, a system can be designed to supply a voltage potential of about 5 volts or less, such as from about 1 to about 3 volts across the electrodes.

A system can include a storage tank 14 that can retain the electrode electrolyte solution suitably connected to flow lines 16 and pump 18 so as to provide circulation of the electrode electrolyte solution between the areas 7, 10 adjacent electrodes 4, 6 during operation.

The system also includes a storage tank 15 that can retain a salt solution suitably connected to flow lines 16 and pump 18 so as to provide circulation of the salt solution to and from area 8 during operation. Of course, the inclusion of a storage tank 15 for the salt solution is not necessarily included in all embodiments, and in some embodiments the salt solution to be treated by the system can be pumped or otherwise provided directly from a source, e.g., a brine pond, a saltwater source, etc.

The salt solution stored and provided to area 8 during use of a cell 20 in such as by use of a storage tank 15 can include the targeted ion of choice, generally in conjunction with one or more additional salts. The salt solution can be obtained directly from the source water that carries the targeted ion of interest, e.g., seawater, brackish water, natural or synthetic brine, wastewater, etc., or may be pre-treated prior to processing by disclosed systems. For instance, a source salt solution can be pretreated by filtering, dilution, or the like prior to being provided to disclosed system.

The storage tank 17 can retain a receiving solution and can be connected to flow lines 16 and pump 18 so as to provide circulation of the receiving solution to and from area 10 during operation. The preferred receiving solution to be utilized in any particular embodiment can generally depend upon the specific characteristics of an application. For instance, in an embodiment in which the targeted ion is lithium, the receiving solution can be an aqueous hydrochloric acid solution, e.g., a 0.01M HCl solution, which can then be evaporated to yield anhydrous lithium chloride suitable for producing lithium metal, e.g., via an electrolysis process as is generally known in the art.

The receiving solution can include a relatively low concentration of a solute for improving its ion conductivity at the early extraction stage. The added solute can be selected so as to not contaminate the extracted mineral ions. In some embodiments, a salt of the mineral ions to be extracted can be including in the receiving solution. Suitable solutes can include those that can be removed relatively easily, for instance via evaporation. Examples of evaporative solutes can include, without limitation, HCl, HNO₃, etc. In some embodiments, a receiving solution can include an ammonium salt that can easily decompose, e.g., NH₄Cl, etc. Hydrochloric acid can be utilized in some embodiments as this acid can be easily removed via evaporation and the extracted metal, e.g., lithium can be easily quantified.

During use, under an applied cell voltage, the electrode electrolyte solution can be pumped from the storage tank 14 through the areas 7, 8 where the redox component will be oxidized and then reduced at the respective current collector of each electrode 4, 6. Upon the change in the redox state of the redox component, ions of the salt solution will be driven from area 7 to area 8 and from area 10 to area 9 through the respective ion exchange membranes. This ion flow in turn encourages flow of the targeted ion in the salt solution provided to area 8 from the storage tank 15 to through the ion-selective ceramic membrane and to the receiving solution provided to area 9. This ion flow to the receiving solution can thus neutralize the extra charge generated by the redox process in the adjacent area, resulting in the concentration of the targeted ions in the receiving solution within area 10.

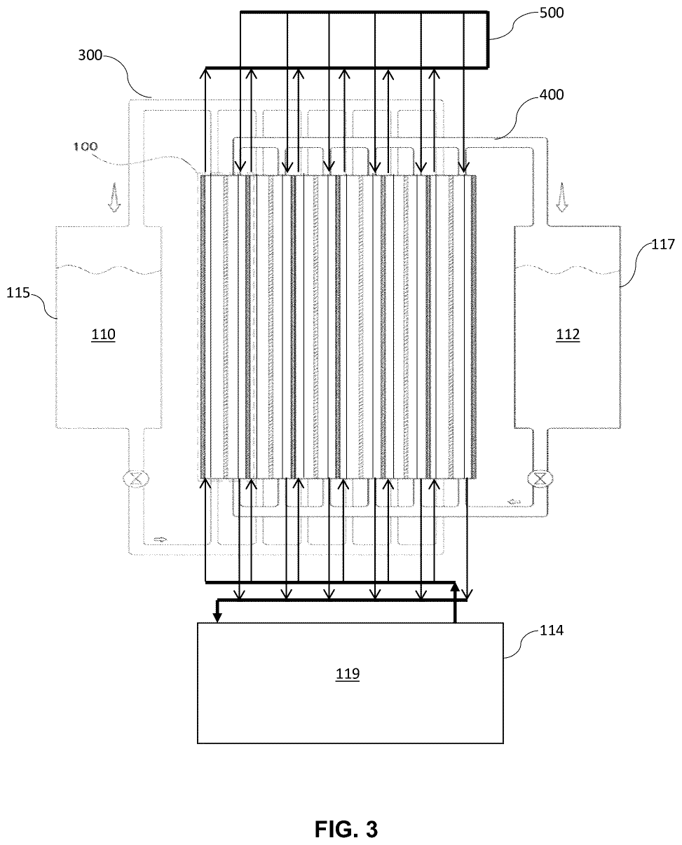

Of course, disclosed systems are not limited to systems that include only a single electrochemical cell 10 as illustrated in FIG. 2, and in other embodiments, a system can include a plurality of individual electrochemical cells in parallel and/or in series with one another. By way of example, FIG. 3 illustrates a system that includes a plurality of electrochemical cells arranged in a parallel multi-cell stack 100 of a multi-cell system. As shown, a first circulation path 300 can pass through one area of each of the cells of the stack 100 such that the salt solution 110 flows through the path 300 and returns to the first tank 115. A second circulation path 400 passes through an adjacent area of each of the cells of the stack 100 such that the receiving solution 112 flows through the path 400 and returns to the second tank 200. These adjacent areas within each individual cell are then separated from one another by an ion-selective ceramic membrane so as to encourage flow of the targeted ion from the salt solution to the receiving solution within each cell. As indicated in FIG. 3, the system can further include a third circulation path 500 via which the electrode electrolyte solution 119 flows through the path 500 and circulates from the first electrode to the second electrode in each cell and then returns to the third tank 114. The electrodes of the adjacent cells can be separated from one another by separators and/or end plates as are known in the art and a multi-cell system can further include respective charging/discharging circuits, as well as converters, controllers, etc. as are known in the art to supply power to the individual cells.

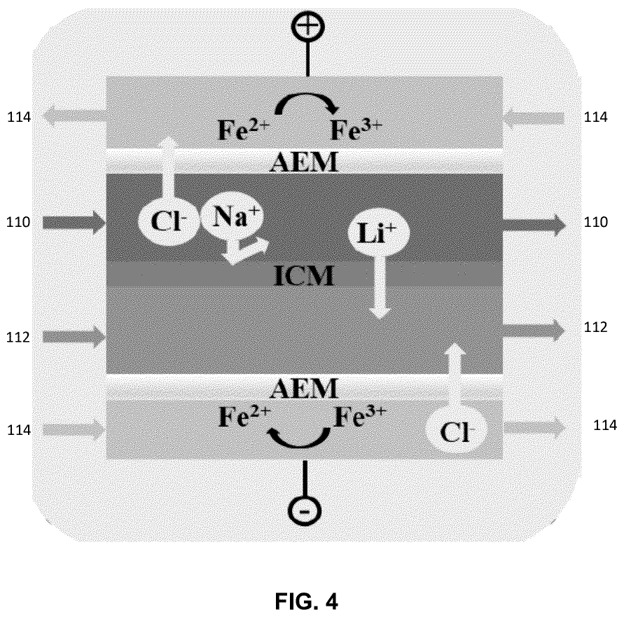

FIG. 4 illustrates one exemplary embodiment of a method for mining lithium from a water source by use of an electrochemical cell as disclosed herein. As illustrated, an electrode electrolyte solution 114 can include an iron-based redox component that can be oxidized from Fe²⁺ to Fe³⁺ at the positive electrode. Meanwhile, a salt solution that includes a lithium salt and, in this embodiment sodium chloride can be provided in the adjacent area that is separated from the electrode electrolyte solution 114 at the positive electrode by an anion exchange membrane, AEM. Upon the oxidation of the redox component, the electrical gradient will drive flow of chlorine ions from the salt solution 110 across the AEM to the electrode electrolyte solution 114 at the positive electrode. This in turn will increase the net charge of the salt solution, resulting in the flow of lithium ions across the ion-selective ceramic membrane, ICM, and into the receiving solution 112 that is in the adjacent area. Upon circulation of the electrode electrolyte solution 114 to the negative electrode, the redox component will be reduced back to Fe²⁺. This will then drive the flow of chlorine atoms out of the electrode electrolyte solution, across the second AEM, and into the receiving solution. The receiving solution 112, which now contains an amount of lithium chloride that is highly concentrated as compared to the salt solution 110, can then be collected and processed according to standard techniques, e.g., electrolysis for recovery of the lithium metal.

The presently disclosed systems can successfully overcome the difficulties of seawater/brine water extraction as known in the past and can be applied for selectively pre-concentrating and extracting ions of many types.

The present invention may be better understood with reference to the example set forth below.

### EXAMPLE

A Ferric Chloride and Ferrous Chloride mixture solution was employed as the electrode electrolyte solution, and Li_{6/16}Sr_{7/16} Ta_{3/4}Hf_{1/4}O₃ perovskite membrane as a lithium selective ceramic membrane. Lithium ions were extracted into 0.01M hydrochloride solution from simulated seawater. The concentration of lithium in the receiving solution reaching as high as 50 times its initial concentration in simulated seawater was demonstrated.

While certain embodiments of the disclosed subject matter have been described using specific terms, such description is for illustrative purposes only, and it is to be understood that changes and variations may be made without departing from the spirit or scope of the subject matter.

What is claimed is:

1. An electrochemical cell for extraction of an ion from a salt solution, comprising:
a first electrode and a second electrode configured for electrical communication with a power supply;
an electrode electrolyte solution comprising at least one redox component;
a first flow path configured to circulate the electrode electrolyte solution between first and second areas that are adjacent to the first and second electrodes, respectively;
a third area separated from the first area by a first ion exchange membrane;
a fourth area separated from the second area by a second ion exchange membrane; and
an ion-selective membrane separating the third area and the fourth area.

2. The electrochemical cell of claim 1, wherein the redox component comprises one or more of titanium, vanadium, chromium, manganese, iron, cobalt, nickel, copper, zinc, ruthenium, tine, cerium, tungsten, osmium, lead, zincate, aluminate, chlorine, chloride, bromine, bromide, tribromide, iodine, iodide, triiodide, polyhalide, halide oxyanion, sulfide, polysulfide, sulfur oxyanion, ferrocyanide, ferricyanide, a quinone derivative, an alloxazine derivative, a flavin derivative, a viologen derivative, a metallocene derivative, a nitroxide radical derivative, a N,N-dialkyl-N-oxoammonium derivative, a nitronyl nitroxide radical derivative, or a polymer incorporating a complexed or covalently bound component of any one of these.

3. The electrochemical cell of claim 2, wherein the redox component comprises iron.

4. The electrochemical cell of claim 1, wherein the electrode electrolyte solution comprises the redox component in a concentration of from about 0.1 M to about 5 M.

5. The electrochemical cell of claim 1, wherein the first ion exchange membrane and the second ion exchange membrane are anion exchange membranes.

6. The electrochemical cell of claim 1, wherein the first ion exchange membrane and the second ion exchange membrane are cation exchange membranes.

7. The electrochemical cell of claim 1, wherein the ion-selective membrane comprises an ion-selective ceramic membrane.

8. The electrochemical cell of claim 7, wherein the ion-selective ceramic membrane comprises an oxide, a sulfide, a selenide, a phosphate, a silicate, a perovskite, a zeolite, a layered hydroxide, or a polymeric composite thereof.

9. The electrochemical cell of claim 8, wherein the ion-selective ceramic membrane is a lithium ion-selective ceramic membrane.

10. A system comprising the electrochemical cell of claim 1 comprising a power supply in electrical communication with the first and second electrodes.

11. The system of claim 10, wherein the power supply comprises a solar power supply or a wind-driven power supply.

12. The system of claim 10, comprising a first storage tank in fluid communication with the first area and the second area, the first storage tank retaining the electrode electrolyte solution.

13. The system of claim 10, further comprising a second storage tank in fluid communication with the third area and a fourth storage tank in fluid communication with the fourth area.

14. The system of claim 10, wherein the system comprises a plurality of electrochemical cells in parallel and/or series with one another.

15. A method for extracting a targeted ion from a salt solution, comprising:
establishing a voltage potential across a first electrode and a second electrode;
circulating an electrode electrolyte solution between a first area and a second area, the first area being in electrical communication with the first electrode and being adjacent to a first side of a first ion exchange membrane, the second area being in electrical communication with the second electrode and being adjacent to a first side of a second ion exchange membrane;
providing a salt solution to a third area, the salt solution comprising the targeted ion, the third area being adjacent to a second side of the first ion exchange membrane and also being adjacent to a first side of an ion-selective membrane that is selective for the targeted ion;
providing a receiving solution to a fourth area, the fourth area being adjacent to a second side of the second ion exchange membrane and also being adjacent to a second side of the ion-selective membrane; wherein
upon establishment of the voltage potential, the targeted ion is driven across the ion-selective membrane from the salt solution to the receiving solution.

16. The method of claim 15, wherein the salt solution comprises seawater, wastewater, natural brine, synthetic brine, or brackish water.

17. The method of claim 15, further comprising forming or pre-treating the salt solution.

18. The method of claim 15, wherein the voltage potential across the first and second electrodes is from about 1 volt to about 5 volts.

19. The method of claim 15, wherein the targeted ion is lithium.

20. The method of claim 15, wherein the receiving solution is an aqueous hydrochloric acid solution.
